(19) United States
(12) Patent Application Publication
(10) Pub. No.: US 2020/0223748 A1
(43) Pub. Date: Jul. 16, 2020

(54) ANTIFOGGING GLASS ARTICLE

(71) Applicant: AGC Inc., Tokyo (JP)

(72) Inventors: Kazuyoshi NODA, Tokyo (JP); Takayuki KIMURA, Tokyo (JP)

(73) Assignee: AGC Inc., Tokyo (JP)

(21) Appl. No.: 16/837,139

(22) Filed: Apr. 1, 2020

Related U.S. Application Data
(63) Continuation of application No. PCT/JP2018/038141, filed on Oct. 12, 2018.

(30) Foreign Application Priority Data
Oct. 23, 2017 (JP) 2017-204183

(51) Int. Cl. C03C 17/32; B60S 1/02

(52) U.S. Cl. CPC C03C 17/322; C03C 2217/70; B60S 1/023; C03C 17/32

(57) ABSTRACT

An antifogging glass article includes a glass plate and a water absorption layer on at least a part of a surface of the glass plate. The water absorption layer includes a saturated water absorption amount of 200 mg/cm³ or more, a thickness of 2 to 50 μm, and a moisture diffusion coefficient of 8×10⁻¹⁴ m²/s or more measured at a temperature of 0° C. by a method defined in JIS K 7209.

### CROSS-REFERENCE TO RELATED APPLICATIONS

This is a Bypass Continuation of International Patent Application No. PCT/JP2018/038141, filed on Oct. 12, 2018, which claims priority from Japanese patent application No. 2017-204183, filed on Oct. 23, 2017. The contents of these applications are hereby incorporated herein in their entireties by reference.

### BACKGROUND OF THE INVENTION

The present disclosure relates to an antifogging glass article. In particular, the present disclosure relates to an antifogging glass article optimized to be suitable for actual use, particularly, when used in a vehicle such as an automobile.

A phenomenon of so-called “fog” is known to appear on a window glass used for outdoor applications, such as a window glass for vehicles including automobiles and window glass for buildings. The phenomenon of “fog” is, when a glass surface becomes a dew point or less, fine water droplets adhere to the window glass, and thus the transparency of the window glass is impaired. There is a known antifogging glass article in which, for example, a water absorption resin layer is provided on an indoor surface of a window glass to absorb and remove the fine water droplets adhered to the indoor surface in order to prevent fogging from occurring (e.g., See International Patent Publication No. WO2013/089165 (Patent Literature 1) and International Patent Publication No. WO2013/183441 (Patent Literature 2).

However, International Patent Publication No. WO2013/089165 (Patent Literature 1) and International Patent Publication No. WO2013/183441 (Patent Literature 2) do not disclose an antifogging glass article that has an antifogging property suitable for actual use, for example, one that has an antifogging property level that ensures there is an enough time for fog to appear when an automobile starts to travel in an environment with a low outside air temperature.

### SUMMARY OF THE INVENTION

The present disclosure has been made in view of the above point. An object of the present disclosure is to provide an antifogging glass article that has an antifogging property suitable for actual use, in particular, one that has an antifogging property level that ensures there is an enough time for fog to appear when an automobile starts to travel in an environment with a low outside air temperature.

In an example aspect, an antifogging glass article includes: a glass plate; and a water absorption layer on at least a part of a surface of the glass plate. The water absorption layer includes a saturated water absorption amount of 200 mg/cm³ or more, a thickness of 2 to 50 μm, and a moisture diffusion coefficient of 8×10⁻¹⁴ m²/s or more measured at a temperature of 0° C. by a method defined in JIS K 7209.

The above and other objects, features and advantages of the present invention will become more fully understood from the detailed description given hereinbelow which is given by way of illustration only, and thus is not to be considered as limiting the present invention.

### DESCRIPTION OF THE EXEMPLARY EMBODIMENTS

Hereinafter, embodiments of the present disclosure will be described. Note that the present disclosure is not limited to these embodiments, and these embodiments can be changed or modified without departing from the spirit and the scope of the present disclosure. The term “to” between numerical values indicating a numerical range means that the numerical values described before and after “to” are included as a lower limit value and an upper limit value in the numerical range.

The antifogging glass article according to the present disclosure includes a glass plate and a water absorption layer that satisfies the following requirements (1a) to (3a) on at least a part of a surface of the glass plate.
(1a) The saturated water absorption amount is 200 mg/cm³ or more.
(2a) The thickness is 2 to 50 μm.
(3a) The moisture diffusion coefficient measured at a temperature of 0° C. by a method defined in JIS K 7209 is 8×10⁻¹⁴ m²/s or more. Hereinafter, the moisture diffusion coefficient measured at a temperature of 0° C. by the method defined in JIS K 7209 is referred to as a “moisture diffusion coefficient D”.

In the antifogging glass article according to the present disclosure, an antifogging property suitable for actual use can be achieved when the water absorption layer satisfies the requirements (1a) to (3a). More specifically, it is possible to achieve an antifogging property level that can ensure that there is an enough time for fog to appear when an automobile starts to travel in an environment with a low outside air temperature.

The antifogging glass article according to the present disclosure includes a glass plate and a water absorption layer on the surface of at least a part of the glass plate. Including a water absorption layer on a surface of at least a part of the glass plate includes a case in which the water absorption layer is in contact with the surface of the glass plate and a case in which another layer is provided between the surface of the water absorption layer and the glass plate. The antifogging glass article according to the present disclosure preferably includes an adhesive layer and a base film layer between the water absorption layer and the glass plate in this order from the side close to the glass plate, and further includes a protective film layer on the surface of the water absorption layer which is brought into contact with air. For example, the antifogging glass article having such a configuration can be produced by providing an antifogging film on the glass plate in such a way that an adhesive layer included in the antifogging film is brought into contact with the glass plate. The antifogging film includes a base film layer. The antifogging film includes a water absorption layer and a protective film layer in this order from the side close to the base film layer on one main surface of the base film layer. The antifogging film includes an adhesive layer on the other main surface of the base film layer. By using the above antifogging film, it is possible to easily provide a water absorption layer having almost no distortion even in a small area of the glass plate surface such as an information acquisition area of a camera or the like.

The application of the antifogging glass article according to the present disclosure is not particularly limited. The antifogging glass article according to the present disclosure is suitable for window glasses for buildings, window glasses for vehicles, etc. which are likely to be used in an environment where an outside air temperature is low, but it is particularly suitable for window glasses for vehicles. Among various kinds of window glasses for vehicle, when the antifogging glass article according to the present disclosure is used as a windshield of an automobile, it is possible to achieve a remarkable effect of achieving an antifogging property level that can ensure that there is an enough time for fog to appear when the automobile starts to travel in an environment with a low outside air temperature and a remarkable effect of achieving both comfort inside the car and safety.

When an automobile starts to travel in an environment where an outside air temperature is low (hereinafter, referred to as “cold start”), in-vehicle air conditioning control with priority on raising the temperature is required in order to make the in-vehicle environment for passengers comfortable. However, it is desirable that an internal air circulation mode and a defroster reheat dehumidification be not operated at the cold start, because engine cooling water as a heat source of a heater is not sufficiently heated, and the heater does not operate well. Under such conditions, particularly the windshield of the automobile is likely to be fogged, and thus it is assumed that a dangerous situation that blocks vision during driving may occur.

In such an assumed environment, for example, when an occurrence of fog can be delayed for a predetermined time from the cold start, it is possible to achieve the comfort of the in-vehicle environment and to ensure the visibility of the passenger. To be more specific, when the antifogging glass article according to the present disclosure is used as a windshield of an automobile, the time until fog occurs when a simulation is performed under the following conditions can be 5 minutes or longer. It is thus possible to achieve the conformable in-vehicle environment and to ensure the visibility of a passenger while driving an automobile in an environment where an outside air temperature is low. For example, when the time until fog occurs is 5 minutes after the cold start, it is considered as an enough time to perform an operation for preventing fog on the windshield, for example, performing a manual operation for starting a defroster and changing to an outside air introduction mode after raising the temperature inside the automobile preferentially.

### (Simulation Conditions)

Initial in-vehicle and outside air relative humidity=50%

Initial in-vehicle and outside air temperature=0° C.

Travel speed=40 km/hr

Car cabin volume=3.8 m³

Air conditioning mode=maximum in the foot mode

Fan operation start=3 minutes after driving is started

Dehumidification function=OFF

Outside air introduction rate=22.8 m³/hr (assuming that ventilation of 60 cycles/hr=3.8×60=228 m³/hr is the maximum air flow of air conditioning, and that 10% of air circulation is exchange of air between internal and external air in the internal air circulation mode)

Passenger capacity=4 passengers (in passenger breath, a steam generation rate per person is set to 58 g/hr, which is a typical steam generation rate.)

The saturated water absorption amount of the water absorption layer according to the requirement (1a) is an index indicating a maximum water absorption amount per unit volume under a predetermined condition (without a time factor). The saturated water absorption amount can be measured by the following method using a glass plate with a water absorption layer as a test piece.

### (Method for Measuring Saturated Water Absorption Amount)

A glass plate with a water absorption layer is used as a test piece. The test piece is left in a room with a temperature of 25° C. and a relative humidity of 50±10% for 24 hours, and then left in a thermo-hygrostat chamber set at a temperature of 25° C. and a relative humidity of 90% for 15 minutes or longer. Right after taking out the test piece from the thermo-hygrostat chamber, the moisture content (I) of the test piece is measured using a trace moisture meter. Further, the moisture content (II) is measured by the procedure similar to the above-described procedure for a glass plate alone with no water absorption layer. The value obtained by subtracting the moisture content (II) from the moisture content (I) and dividing the subtracted value by a volume of the water absorption layer is defined as the saturated water absorption amount.

The moisture content is measured as follows using a micro moisture analyzer FM-300 (manufactured by Kett Electric Laboratory). A sample to be measured is heated at 120° C., and vapors are passed through activated carbon to remove vapors other than moisture. After that, the moisture is adsorbed in molecular sieves in the micro moisture analyzer, and a change in the mass of the molecular sieves is measured as the moisture content. The end point of the measurement is the point when an amount of change in the mass of the molecular sieves per minute becomes 0.02 mg or less.

The evaluation can be performed by using a sample (water absorption layer has an area of 12 cm²) produced using, for example, a soda lime glass plate with 3 cm×4 cm×thickness of 2 mm. However, the present disclosure is not limited to this.

When the saturated water absorption amount of the water absorption layer is 200 mg/cm³ or more, the water absorption property is high. When this requirement of the saturated water absorption amount is combined with the requirements (2a) and (3a), the antifogging property suitable for actual use can be ensured. For example, the time until fog occurs in the above simulation can be 5 minutes or longer. On the other hand, the saturated water absorption amount of the water absorption layer is preferably 900 mg/cm³ or less, and more preferably 500 mg/cm³ or less, in terms of preventing the durability of the water absorption layer from being reduced.

The saturated water absorption amount of the water absorption layer is preferably 300 mg/cm³ or more, and more preferably 400 mg/cm³ or more, in terms of improving the water absorption property. The saturated water absorption amount of the water absorption layer is preferably within the range of 300 and 900 mg/cm³, in terms of the water absorption property and durability.

The requirement (2a) relates to a film thickness of the water absorption layer. The film thickness can be measured using, for example, a scanning electron microscope image of a cross section of the water absorption layer. By increasing the film thickness of the water absorption layer, a sufficient volume of the water absorption layer can be ensured, and the water absorption amount per unit area of the water absorption layer can be increased. When the film thickness of the water absorption layer is 2 μm or more, the volume of the water absorption layer is sufficient. When this requirement of the film thickness of the water absorption layer is combined with the requirements (1a) and (3a), the antifogging property suitable for actual use can be ensured. For example, the time until fog occurs in the above simulation can be 5 minutes or longer. On the other hand, the film thickness of the water absorption layer is 50 μm or less, in terms of preventing the durability of the antifogging film from being lowered.

The film thickness of the water absorption layer is preferably 3 μm or more, more preferably 21 μm or more, and particularly preferably 30 μm or more, in terms of increasing the water absorption amount per unit area of the water absorption layer. The film thickness of the water absorption layer is preferably within the range of 21 to 50 μm (hereinafter also referred to as a requirement (2b)), in terms of the water absorption amount and durability. When this requirement of the film thickness of the water absorption layer being 21 μm or more is combined with the requirement (1a) and the following requirement (3b), an improved antifogging property can be ensured in actual use. For example, the time until fog occurs in the simulation can be 15 minutes or longer.

The moisture diffusion coefficient D in the requirement (3a) is an index indicating how easy it is for moisture to be diffused inside the water absorption layer at 0° C. Here, the moisture diffusion coefficient is temperature dependent, and the lower the temperature, the smaller the moisture diffusion coefficient value becomes. In the present disclosure, the antifogging property suitable for actual use is targeted at, for example, an antifogging property level that can ensure that there is an enough time for fog to appear when an automobile starts to travel in an environment with a low outside air temperature. Thus, the condition of the temperature for the moisture diffusion coefficient is set at 0° C.

The moisture diffusion coefficient D of the water absorption layer is measured at a temperature of 0° C. in accordance with JIS K 7209. In the present disclosure, the moisture diffusion coefficient D may be a value calculated by the following method using a glass plate with a water absorption layer. That is, under the condition of the temperature 0° C., the glass plate with the water absorption layer is exposed sufficiently in a low humidity environment so that the glass plate is in a dry equilibrium state. After that, a time profile of a change in the mass of the glass plate with the absorption layer by moisture absorption when the glass plate with the absorption layer is transferred to a high humidity environment is measured. The moisture diffusion coefficient D can also be identified by fitting the measured value to the time profile of the change in the mass by a moisture diffusion model of a thin film having a known moisture diffusion coefficient D prepared in advance.

For example, even with the same saturated water absorption amount in the water absorption layer, when the moisture content supplied from outside per unit time is large, the moisture is not sufficiently diffused inside the water absorption layer if the moisture diffusion coefficient D is small, thereby causing fog to quickly appear on the surface of the water absorption layer. When the moisture diffusion coefficient D of the water absorption layer is 8×10⁻¹⁴ m²/s or more, the moisture diffusibility at a low temperatures is high. Thus, when this requirement of the moisture diffusion coefficient D of the water absorption layer is combined with the requirements (1a) and (2a), the antifogging property suitable for actual use can be ensured. For example, the time until fog occurs in the simulation can be 5 minutes or longer.

The moisture diffusion coefficient D of the water absorption layer is preferably 1×10⁻¹³ m²/s or more, more preferably 6×10⁻¹³ m²/s or more, and further preferably 1×10⁻¹² m²/s, and even more preferably 4×10⁻¹² m²/s or more, in terms of improving the water diffusibility at a low temperature. When the requirement (3b) is that the moisture diffusion coefficient D of the water absorption layer is 6×10⁻¹³ m²/s or more, and when this requirement (3b) is combined with the requirements (1a) and (2b), it is possible to ensure a high antifogging property in actual use. For example, the time until fog occurs in the simulation can be 15 minutes or longer.

The moisture diffusion coefficient D of the water absorption layer is preferably 1×10⁻¹⁰ m²/s or less. When the moisture diffusion coefficient D is 1×10⁻¹⁰ m²/s or less, it becomes easy to maintain the same touch (i.e., static friction coefficient or dynamic friction coefficient) of the surface of the water absorption layer before and after the water absorption. Furthermore, the abrasion resistance property of the water absorption layer is improved. The moisture diffusion coefficient D is further preferably 2×10⁻¹¹ m²/s or less, and particularly preferably 5×10⁻¹² m²/s or less.

Moreover, examples of the conditions for setting the time until fog occurs in the above simulation to 10 minutes or longer include the following (1-1) to (1-3) as combinations of the saturated water absorption amount, the film thickness, and the moisture diffusion coefficient D.
(1-1) Saturated water absorption amount: 300 mg/cm³ or more, film thickness: 10 to 18 μm, moisture diffusion coefficient D: 3×10⁻¹³ m²/s or more,
(1-2) Saturated water absorption amount: 300 mg/cm³ or more, film thickness: 10 to 50 μm, moisture diffusion coefficient D: 3×10⁻¹³ m²/s or more and 1×10⁻¹⁰ m²/s or less, and
(1-3) Saturated water absorption amount: 200 mg/cm³ or more, film thickness: 10 to 50 μm, moisture diffusion coefficient D: 3×10⁻¹³ m²/s or more and 1×10⁻10 m²/s or less.

Likewise, examples of the conditions for setting the time until fog occurs in the above simulation to be 20 minutes or longer include the following (2-1) to (2-3) as combinations of the saturated water absorption amount, the film thickness, and the moisture diffusion coefficient D.
(2-1) Saturated water absorption amount: 300 mg/cm³ or more, film thickness: 27 to 35 μm, moisture diffusion coefficient D: 6×10⁻¹³ m²/s or more,
(2-2) Saturated water absorption amount: 300 mg/cm³ or more, film thickness: 27 to 50 μm, moisture diffusion coefficient D: 6×10⁻¹³ m²/s or more and 1×10⁻¹⁰ m²/s or less, and
(2-3) Saturated water absorption amount: 200 mg/cm³ or more, film thickness: 27 to 50 μm, moisture diffusion coefficient D: 6×10⁻¹³ m²/s or more and 1×10⁻¹⁰ m²/s or less.

In the antifogging glass article according to the present disclosure, it is preferable that the water absorption layer further satisfy the requirement (4a).

(4a) The pencil hardness measured at a temperature of 23° C. and a relative humidity of 50% by the method defined in JIS K 5600 is F to 4H.

When the water absorption layer satisfies the requirement (4a), the moisture diffusion coefficient D can be controlled to 8×10⁻¹⁴ m²/s to 2×10⁻¹¹ m²/s, and an antifogging property suitable for actual use can be achieved. Note that in the present disclosure, the pencil hardness is measured after an antifogging glass article with a water absorption layer is held in an environment of a temperature of 23±2° C. and a relative humidity of 50±5% for 16 hours or longer.

The water absorption layer with a pencil hardness of the surface of F or more has a scratch resistance property against, for example, a wet cloth or a dry cloth. Moreover, the water absorption layer with a pencil hardness of the surface of H or more has, for example, a scratch resistance property against nails and plastic pieces. Furthermore, the water absorption layer with a pencil hardness of the surface of 3 H or more has a scratch resistance property against, for example, a rubber weather-strip or a nylon dustproof cloth in a vertically movable part of a window glass.

The antifogging glass article according to the present disclosure includes a glass plate and a water absorption layer satisfying the requirements (1a), (2a), and (3a) on at least a part of a surface of the glass plate. The water absorption layer is commonly provided on one main surface of the glass plate. An area where the absorption layer is formed may be provided on the entire main surface of the glass plate or on a part of the main surface of the glass plate. When the water absorption layer is provided on a part of the main surface of the glass plate, the antifogging glass article can be easily produced by using the above-described antifogging film. When the antifogging glass article is a window glass for vehicles, the water absorption layer is provided on the main surface of the glass plate inside the car. When the antifogging glass article is a window glass for buildings, the water absorption layer is provided on the main surface of the glass plate inside the room.

The antifogging glass article according to the present disclosure may include a specific layer other than the glass plate and the water absorption layer. An example of the specific layer includes a base layer formed between the glass plate and the water absorption layer. Moreover, when the antifogging glass article is a window glass for vehicles, the glass plate may include a black ceramic layer in a peripheral part of the glass plate.

As the glass plate, a glass plate commonly used for a window glass for buildings or for vehicles or the like may be used without particular limitation. Specifically, a glass plate made of plastic, glass, or a combination thereof (such as a laminated material) is preferably used as the glass plate.

An ordinary soda lime glass (also referred to as soda lime silicate glass), borosilicate glass, alkali-free glass, quartz glass, etc. are used as the glass without particular limitation. Among these glasses, a soda lime glass is particularly preferable. Alternatively, a glass that absorbs ultraviolet rays or infrared rays may be used. The forming method is not limited in particular. However, for example, a glass plate formed by the floating method or the like is preferable. Examples of the plastic include an acrylic-based resin such as polymethyl methacrylate, an aromatic polycarbonate-based resin such as polyphenylene carbonate, and an aromatic polyester-based resin such as polyethylene terephthalate (PET). Among these resins, an aromatic polycarbonate-based resin is preferable.

The glass plate may be a general-purpose plate glass, a tempered glass, or a glass with metal wire. The glass plate may be a laminated glass obtained by laminating a plurality of glass plates with intermediate layers interposed therebetween, or a multi-layer glass obtained by laminating a plurality of glass plates in such a way that air layers are formed by spacers between the respective plurality of glass plates. The shape and thickness of the glass plate can be appropriately selected according to the application. The shape of the glass plate may be a flat plate, or an entire surface or a part of the surface may have a curvature. Commonly, the thickness of the glass plate is preferably 1 to 10 mm.

The configuration of the water absorption layer is not particularly limited as long as it satisfies all the requirements (1a), (2a), and (3a).

Examples of the water absorption layer include a water absorption layer containing a water absorption material such as a water absorption resin and porous inorganic fine particles. The water absorption resin has a water absorption property by combined actions of a hydrophilic group present in a molecule and a cross-linked structure of the molecule, and the porous inorganic fine particles have a water absorption property by including a large number of pores. When a water absorption resin is used, the water absorption layer may be formed only of the water absorption resin, because the resin itself has a film forming property. When porous inorganic fine particles are used, a binder component is preferably added to form a water absorption layer in which porous inorganic fine particles are dispersed.

In the antifogging glass article according to the present disclosure, a water absorption layer formed using a water absorption resin is preferable. The water absorption layer is preferably composed only of a water absorption resin, in terms of a water absorption property. However, the water absorption layer may be formed of a combination of a water absorption resin and a material having excellent mechanical strength while ensuring a water absorption property depending on the type of the resin to be used in terms of the wear resistance property. The percentage of the water absorption resin to the total amount of the water absorption layer is preferably 70 to 100% by mass, and more preferably 80 to 100% by mass, although it depends on the type of the water absorption resin.

A water absorption resin that satisfies the requirements (1a) and (3a) when the water absorption layer is formed only of the water absorption resin or formed of a combination of the water absorption resin and another material(s) is used as the water absorption resin. Examples of the water absorption resins include a resin having a hydrophilic group or a hydrophilic chain (such as polyoxyethylene group). The water absorption resin may be a linear polymer or a non-linear polymer, but is preferably a curable resin that is a non-linear polymer including a three-dimensional network structure, in terms of, for example, durability. The water absorption resin preferably includes a curable resin that is a linear polymer, in terms of increasing the moisture diffusion coefficient D of the water absorption layer.

The curable resin is a cured product of a curable component. The curable component refers to a combination of a compound including a reactive group (monomer, oligomer, polymer, etc.) and a curing agent. One reactive compound of the curable component may be referred to as a main agent. The curing agent refers to the other reactive compound that reacts with the main agent, and also refers to a reaction initiator such as a radical generator that causes an addition-polymerizable unsaturated group to react and a reaction catalyst such as a Lewis acid. Hereinafter, when the water absorption layer includes a water absorption resin, the relationship between the water absorption layer, the saturated water absorption amount, and the moisture diffusion coefficient D especially when the above-described preferred range of the water absorption resin is included will be described.

Since the saturated water absorption amount of the water absorption layer is related to the amount of the hydrophilic group of the water absorption resin, the saturated water absorption amount of the water absorption layer can be controlled by adjusting the amount of the hydrophilic group. Examples of the hydrophilic groups include a hydroxyl group, a carboxyl group, a sulfonyl group, an amide group, an amino group, a quaternary ammonium base, and an oxyalkylene group. When the water absorption resin is a curable resin, an amount of the hydrophilic group of the curable resin can be controlled by adjusting the amount of the hydrophilic group (e.g., hydroxyl value) included in the main agent and/or the curing agent. Moreover, when the hydrophilic group is formed by a curing reaction in the curable resin, the saturated water absorption amount of the water absorption layer can be controlled by adjusting the number of functional groups and the degree of crosslinking of the main agent and/or the curing agent.

The saturated water absorption amount and the moisture diffusion coefficient D of the water absorption layer depend on the type and the three-dimensional network structure of the water absorption resin. The three-dimensional network structure depends also on, for example, the degree of crosslinking of the water absorption resin. When the number of crosslinking points included in the water absorption resin per unit amount is large, it is considered that the water absorption resin has an elaborate three-dimensional network structure, and the space for water retention is reduced, thereby reducing the saturated water absorption amount. Further, the moisture diffusion coefficient D is considered to be reduced. On the other hand, when the number of crosslinking points included in the water absorption resin per unit amount is small, it is considered that the space for water retention is increased, and the saturated water absorption amount is increased. Further, the moisture diffusion coefficient D is considered to be increased.

Furthermore, when the three-dimensional network structure of the water absorption resin is flexible, the moisture diffusion coefficient D of the water absorption layer can be increased. When the water absorption resin is a curable resin, the type of a curable component and the curing conditions are appropriately selected in order to make the three-dimensional network structure flexible.

A glass transition temperature of a water absorption resin is closely related to a degree of crosslinking and flexibility of the water absorption resin. Commonly, it is considered that a resin having a high glass transition temperature has a high degree of crosslinking contained in the resin per certain unit amount or has low flexibility. Thus, commonly, in order to increase the moisture diffusion coefficient D of the water absorption layer, it is preferable to control the glass transition temperature of the water absorption resin to be low. Specifically, the glass transition temperature of the water absorption resin used in the water absorption layer is preferably 0 to 110° C., more preferably 10 to 100° C., even more preferably 10 to 90° C., further preferably 10 to 80° C., and particularly preferably 20 to 70° C. When the glass transition temperature of the water absorption resin is 0 to 110° C., the moisture diffusion coefficient D of the water absorption layer can be controlled to 8×10⁻¹⁴ m²/s to 2×10⁻¹¹ m²/s, thereby making it easy to achieve the antifogging property suitable for actual use.

The glass transition temperature of the water absorption resin is a value measured in accordance with JIS K 7121. Specifically, a water absorption layer made of a water absorption resin as a specimen is provided on a substrate, for example, a soda lime glass substrate, and left in an environment of 20° C. and a relative humidity of 50% for one hour. After that, the glass transition temperature of this water absorption layer is measured using, for example, DSC-60 (manufactured by Shimadzu Corporation). Here, the heating rate during the measurement shall be 10° C./min.

When a curable resin made of a cured product including a curable component is used as the water absorption resin, viscosity of the curable component is closely related to the degree of crosslinking and flexibility of the obtained curable resin (water absorption resin). Commonly, a water absorption resin obtained using a curable component with high viscosity is considered to have a high degree of crosslinking contained in the resin per certain unit amount or to have low flexibility. Thus, commonly, it is preferable to control the viscosity of the curable component to be low in order to increase the moisture diffusion coefficient D of the water absorption layer. Specifically, the viscosity of the curable component used in the water absorption resin constituting the water absorption layer is preferably 10 to 300 mPa·s, more preferably 10 to 200 mPa·s, even more preferably 20 to 150 mPa·s, further preferably 30 to 130 mPa·s, particularly preferably 40 to 120 mPa·s, and most preferably 50 to 100 mPa·s. When the viscosity of the curable component used in the water absorption resin is 10 to 300 mPa·s, the moisture diffusion coefficient D of the obtained water absorption layer can be controlled to 8×10⁻¹⁴ m²/s to 2×10⁻¹¹ m²/s, thereby making it easy to achieve the antifogging property suitable for actual use.

The viscosity is measured at 25° C. using a rotational viscometer (RVDV-E by Brookfield Asset Management Inc.).

When the water absorption resin is a curable resin, a main agent of the curable component is not particularly limited as long as it reacts with a combination of a compound including two or more reactive groups and a curing agent to become a curable resin. This reaction is initiated or promoted by heat or light such as ultraviolet rays. Examples of the reactive group include a group including a polymerizable unsaturated group such as a vinyl group, an acryloyloxy group, a methacryloyloxy group, and a styryl group, and a reactive group such as an epoxy group, an amino group, a hydroxyl group, a carboxyl group, an acid anhydride group, an isocyanate group, a methylol group, a ureido group, a mercapto group, and a sulfide group. Among these groups, an epoxy group, a carboxyl group, and a hydroxyl group are preferable, and an epoxy group is more preferable. Moreover, only one kind of the groups may be used for the main agent or two or more kinds of the groups may be used together.

When the main agent is a low molecular compound or oligomer including a reactive group, the number of reactive groups included in one molecule is preferably 1 to 3, and more preferably 1 to 2. When the number of reactive groups included in one molecule is 1 to 3, the number of crosslinking points of the water absorption resin can be reduced, and the moisture diffusion coefficient D of the water absorption layer can be increased.

Examples of such a curable component include the following resins. A curable acrylic resin composed of a combination of a main agent and a curing agent, in which the main agent is composed of a low molecular compound (monomer) or oligomer including 1 to 3 acryloyloxy groups, and the curing agent is a radical generator. An epoxy resin composed of a combination of a main agent and a curing agent, in which the main agent is composed of a low molecular compound or oligomer including 1 to 3 epoxy groups, and the curing agent is a compound including 1 to 2 reactive groups reactive with an epoxy group such as an amino group. An epoxy resin composed of a combination of a main agent and a curing agent, in which the main agent is a low molecular compound or oligomer including 1 to 3 epoxy groups, and the curing agent is a curing catalyst (such as Lewis acid or base). A curable urethane resin composed of a combination of a polyol and a polyisocyanate (curing agent), in which the polyol is a low molecular compound or oligomer including 1 to 3 hydroxyl groups, and the polyisocyanate (curing agent) is a compound including 1 to 2 isocyanate groups. A curable polyvinyl acetal resin composed of a combination of a main agent and a curing agent, in which the main agent is composed of polyvinyl alcohol with a degree of saponification of 50 to 99.8 mol %, and the curing agent is an aldehyde.

By using a photopolymerization initiator as the curing agent for the curable acrylic resin, a photocurable acrylic resin can be obtained. By using a photocurable agent (e.g., compound that generates Lewis acid and the like by irradiation of light such as ultraviolet rays (UV)) as the curing agent for the epoxy resin, a photocurable epoxy resin can be obtained.

In the present disclosure, a cured product of an epoxy resin is preferably used as the water absorption resin. More specifically, a cured product of an epoxy resin composed of a combination of an aliphatic polyepoxide and an aliphatic curing agent is preferable. A molecular weight of the aliphatic polyepoxide is preferably 300 to 3000, and more preferably 500 to 2000. A molecular weight of the aliphatic curing agent is preferably 300 to 2000. A mixing ratio of the aliphatic polyepoxide and the aliphatic curing agent is preferably such that an equivalent ratio of a reactive group of the aliphatic curing agent to an epoxy group of the aliphatic polyepoxide is 0.5 to 1.0, and more preferably 0.6 to 0.9.

The cured product of the epoxy resin composed of the combination of aliphatic polyepoxide and aliphatic curing agent has a flexible three-dimensional network structure. Further, by adjusting the molecular weight of the aliphatic polyepoxide and aliphatic curing agent, the size of the space of the three-dimensional network structure can be adjusted. By designing the molecular structure of the water absorption resin in this manner, a water absorption layer that satisfies both of the requirements (1a) and (3a) can be obtained. Furthermore, the saturated water absorption amount and the moisture diffusion coefficient D of the water absorption layer can be adjusted by adjusting the curing conditions described later.

In the present specification, a molecular weight refers to a mass average molecular weight (Mw) unless otherwise specified. The mass average molecular weight (Mw) in the present specification means a mass average molecular weight which uses polystyrene as a standard measured by Gel Permeation Chromatography (GPC).

A commercially available product can be used as the polyepoxide. Specific examples of such a commercially available product include those manufactured by Nagase ChemteX Corporation with the product names, Denacol EX-313 (Mw: 383), Denacol EX-314 (Mw: 454), Denacol EX-512 (Mw: 630), Denacol EX-1410 (Mw: 988), Denacol EX-1610 (Mw: 1130), Denacol EX-610U (Mw: 1408), Denacol EX-521 (Mw: 1294), and Denacol EX-622 (Mw): 930).

Example of the commercially available products of the curing agent include Jeffamine T403 (product name, manufactured by Huntsman Corporation, Mw: 390) as polyoxyalkylene triamines, and polythiol QE-340M (product name, manufactured by Toray Fine Chemical) as polyether polythiols.

An optional component can be added to the epoxy resin in addition to the polyepoxide and the curing agent. In the epoxy resin composed of a polyepoxide, a curing agent, and an optional component, a content of the polyepoxide with respect to a total amount of the epoxy resin is preferably 40 to 80% by mass. The total amount of the curing agent is preferably 40% by mass or less. Examples of the optional component include an inorganic filler for increasing the mechanical strength of the water absorption layer, a coupling agent for increasing the adhesion to the glass plate or base layer with which the water absorption layer is brought into contact, a leveling agent used for improving a film-forming property, an antifoaming agent, a viscosity modifier, a light stabilizer, an antioxidant, and a ultraviolet absorber, an infrared absorber.

For example, the water absorption layer including the water absorption resin is formed by preparing a water absorption layer composition including a curable component and, if necessary, the above-mentioned various optional components, and preferably further including a solvent, applying this water absorption layer composition on an area of the glass plate where the absorption layer is formed, drying or drying as necessary the water absorption composition, and then causing a curing reaction.

In the present disclosure, a cured product of a curable polyvinyl acetal resin is also preferably used as the water absorption resin. More specifically, a cured product of a curable polyvinyl acetal resin composed of a combination of polyvinyl alcohol and aldehyde with a degree of saponification of 50 to 99.8 mol % is preferable. The degree of saponification of polyvinyl alcohol is more preferably 60 to 95 mol %, and further preferably 70 to 90 mol %. The degree of acetalization of the curable polyvinyl acetal resin is preferably 20 to 70 mol %, more preferably 30 to 60 mol %, and further preferably 40 to 50 mol %. When the degree of acetalization of the curable polyvinyl acetal resin is 20 to 70 mol %, the moisture diffusion coefficient D of the water absorption layer can be controlled to 8×10⁻¹⁴ m²/s to 2×10⁻¹¹ m²/s, thereby making it easy to achieve the antifogging property suitable for actual use.

In the present disclosure, a cured product of a curable urethane resin is also preferably used as the water absorption resin. More specifically, a cured product of a curable urethane resin composed of a polyol such as a low molecular compound or oligomer including 1 to 3 hydroxyl groups and a polyisocyanate (curing agent) which is a compound including 1 to 2 isocyanate groups is preferable. A mixing ratio of the polyol and the polyisocyanate is preferably such that an equivalent ratio of the reactive group of the polyisocyanate to the hydroxyl group of the polyol is 0.5 to 0.9, and more preferably 0.6 to 0.8. When a curable urethane resin with an equivalent ratio of the reactive group of the polyisocyanate to the hydroxyl group of the polyol of 0.5 to 0.9 is used, the moisture diffusion coefficient D of the obtained water absorption layer is controlled to 8×10⁻¹⁴ m²/s to 2×10⁻¹¹ m²/s, thereby making it easy to achieve the antifogging property suitable for actual use.

Note that the film thickness of the water absorption layer to satisfy the requirement (2a) is commonly controlled by controlling the thickness of a coating film when the water absorption composition is applied. Examples of methods for applying the water absorption layer composition include flow coating method, spin coating method, spray coating method, flexographic printing method, screen printing, gravure printing method, roll coating method, meniscus coating method, die coating method, and wiping method. The film thickness of the coating film can be controlled by any of these methods. Among these methods, the flow coating method, the spin coating method, and the spray coating method are preferable, in terms of easiness of controlling the film thickness. The area where the water absorption layer is formed may be controlled by a known method such as a masking method.

When an epoxy resin, a curable urethane resin, and a curable polyvinyl acetal resin are used, for example, a heat treatment at 50 to 180° C. for about 10 to 60 minutes can be carried out as a curing treatment after the water absorption layer composition is applied. When a curable component that is curable at a room temperature is used, it can be cured at a room temperature. When a photocurable component is used, for example, a treatment such as irradiation with UV of 50 to 1000 mJ/cm² for 5 to 10 seconds by means of a UV curing device or the like may be carried out.

As described above, when this curing treatment is sufficiently performed under extreme conditions, the three-dimensional network structure becomes elaborate, and the saturated water absorption amount and the moisture diffusion coefficient D of the water absorption layer tend to be reduced. Moreover, when the curing treatment is performed under mild conditions, the moisture diffusion coefficient D of the water absorption layer can be increased.

For example, a water absorption layer composition is prepared so as to form a cured product of an epoxy resin including a saturated water absorption amount of 200 mg/cm³ . The moisture diffusion coefficient D of the water absorption layer can be adjusted by setting the temperature condition for the curing of the cured product to be relatively mild, and adjusting a curing time. Specifically, when a water absorption composition including an aliphatic polyglycidyl ether as the aliphatic polyepoxide, and an aliphatic polyamine and a curing catalyst (e.g., an imidazole compound) as the curing agent is used to form a water absorption layer at a predetermined curing temperature, a water absorption layer with a low degree of polymerization, low hardness, and a large moisture diffusion coefficient D can be obtained by reducing the curing time, for example, to 10 minutes, at a curing temperature of about 100° C. When only the curing time is increased, for example, to 50 minutes, under the same conditions as those described above, and then a water absorption layer with a high degree of polymerization, high hardness, and a small moisture diffusion coefficient D is produced.

The base layer is optionally provided in order to improve the adhesion between the water absorption layer and the glass plate. The water absorption layer easily peels off from an adhesive interface because of repeated large expansion and contraction due to a high water absorption property. Thus, for example, by providing a base layer made of a curable resin of the same type as that of the water absorption layer and including a low water absorption property, for example, a saturated water absorption amount of 10 mg/cm³ or less between the water absorption layer and the glass plate, it is possible to prevent the water absorption layer from peeling off from the glass plate.

The thickness of the base layer is preferably about 2 to 8 μm. Furthermore, a ratio of the thickness of the base layer to that of the water absorption layer, when the ratio is calculated by [thickness of water absorption layer/thickness of base layer], is preferably 3.0 to 6.0, and more preferably 3.5 to 5.0, although it depends on the water absorption property of each layer.

### EXAMPLES

Hereinafter, the present disclosure will be described in detail with reference to examples, but the present disclosure is not limited to these examples.

### [Verification of Moisture Absorption and Desorption Diffusion Simulation Calculation Model]

A moisture absorption and desorption diffusion simulation calculation model was built to evaluate antifogging performance of a water absorption layer. A water absorption layer was provided on half of a windshield of a minivan by the following method, and predetermined temperature and humidity data was measured during an actual car running test, and the antifogging property was evaluated. The temperature and humidity data obtained from an actual car running test was input to the moisture absorption and desorption diffusion simulation calculation model to evaluate the antifogging property, the actual measured values of the antifogging property obtained during an actual car running test were compared with the temperature and humidity data, and the validity of the simulation using this model was verified.

(Production of Windshield with Water Absorption Layer)

### <Preparation of Base Layer Composition>

In a glass container in which a stirrer and a thermometer were set, propylene glycol monomethyl ether (150.00 g, manufactured by Daishin Chemical Co., Ltd.), bisphenol A diglycidyl ether (93.17 g, jER828 (product name, manufactured by Mitsubishi Chemical Corporation)), polyoxyalkylenetriamine (38.20 g, Jeffamine T403 (product name, manufactured by Huntsman Corporation)), aminosilane (18.63 g, KBM903 (product name, manufactured by Shin-Etsu Chemical Co., Ltd.)) were placed, and stirred at 25° C. for 30 minutes. Next, the composition was diluted to 5 times with propylene glycol monomethyl ether (manufactured by Daishin Chemical Co., Ltd.), and a leveling agent (0.375 g, BYK307 (product name, manufactured by BYK Additives & Instruments)) was added to obtain a base layer composition.

### <Preparation of Water Absorption Layer Composition>

In a glass container in which a stirrer and a thermometer were set, ethanol (586.30 g, manufactured by Kanto Chemical Co., Inc.), methyl ethyl ketone (196.37 g, manufactured by Kanto Chemical Co., Inc.), aliphatic polyglycidyl ether (248.73 g, Denacol EX-1610, (product name, manufactured by Nagase ChemteX Corporation)), and glycerin polyglycidyl ether (206.65 g, Denacol EX-313, (product name, manufactured by Nagase ChemteX Corporation)) were added and stirred for 10 minutes. Next, organosilica sol (29.92 g, NBAC-ST (product name, manufactured by Nissan Chemical Industries, Ltd.), average primary particle diameter: 10 to 20 nm, SiO₂ content 30% by mass), and 2-methylimidazole (10.29 g, Shikoku Chemicals Corporation) were added and further stirred for 10 minutes. Next, polyoxyalkylene triamine (90.70 g, Jeffamine T403 (product name, manufactured by Huntsman Corporation)) was added and stirred at 25° C. for one hour.

Next, aminosilane (92.57 g, KBM903 (product name, manufactured by Shin-Etsu Chemical Co., Ltd.)) was added while the mixture was being stirred, and the mixture was further stirred at 25° C. for 3 hours. After that, methyl ethyl ketone (438.46 g, manufactured by Kanto Chemical Co., Ltd.) was added while the mixture was being stirred. Furthermore, a leveling agent (0.95 g, BYK307 (product name, manufactured by BYK Additives & Instruments)) was added while the mixture was being stirred, so that a water absorption layer composition was obtained.

### <Formation of Base Layer and Water Absorption Layer>

A windshield of a minivan used for an experiment was a laminated glass (manufactured by AGC) in which soda lime glass plates were laminated with an intermediate film interposed therebetween. A main surface of the windshield inside the car was polished and washed with cerium oxide, the cerium oxide was washed away with pure water, and dried with warm air, so that a clean windshield was obtained. The base layer composition obtained in this manner was applied by the flow coating only on a right half of the main surface of the windshield (driver's seat side) inside the car. After the base layer composition was applied, the windshield was kept in an air circulating oven at a set temperature of 100° C. for 30 minutes, so that a base layer with a thickness of 2 μm was formed. Next, the water absorption layer composition obtained above was applied to the base layer by flow coating, and held in an air circulating oven at a set temperature of 100° C. for 30 minutes, so that a water absorption layer was formed.

The water absorption layer obtained in this manner had a thickness of 4 μm, a saturated water absorption amount of 340 mg/cm³ , a moisture diffusion coefficient D of 3.04×10⁻¹³ [m²/s], and a pencil hardness of 3 H. The obtained water absorption layer was composed of a curable resin obtained by curing a curable component composed of an epoxy resin (main agent and curing agent), organosilica sol, and aminosilane in the water absorption layer composition.

### (Actual Car Running Test)

The windshield with the water absorption layer on its half of the surface obtained in the above described manner was installed to a minivan, and a running test was conducted under the following conditions. A change in the temperature of the windshield was measured by a temperature sensor (thermocouple) attached to the surface of the windshield inside the car, and a change in the temperature and humidity inside the car was measured by a temperature and humidity sensor (manufactured by Sensirion AG) installed near the windshield inside the car, recorded as measurement data at the time of actual measurement, and used in simulations described later. The determination as to whether fog occurred was visually observed by a passenger. A time when a part where moisture remained on the surface of the water absorption layer or an untreated part of the glass plate was observed was defined as a fog occurrence time. The time from when the car started to travel until the fog occurrence time was defined as “fog generation time (t)”. When an upper half of the water absorption layer was fogged, a defroster (hereinafter referred to as “DEF”) was turned on, and DEF continued to operate for a while. Then, the fog disappeared, and the car continued to travel safely without stopping. Note that the time when the automobile started to travel indicates the time when the passenger got on, sat down, and closed the door.

The above test was conducted four times. The results are shown in the actual measurement rows of Table 1. The time from when the car started to travel until the time when DEF was turned on, i.e., until the time when the upper half of the water absorption layer is fogged, is indicated in the bottom rows of Table 1 as “DEF operation start time”. In the display of time in Table 1, ′ indicates minutes and ″ indicates seconds. For example, 1′ 40″ indicates 1 minute and 40 seconds.

### (Test Conditions)

Outside temperature and humidity: −2° C. and 90% RH

Minivan

Number of passengers: 3 passengers+humidification (600 ml/hr)

Travel speed: 40 km/hr

Air conditioning: Heating (25° C. setting), inside air circulation foot mode, compressor OFF

### (Simulation)

A simulation was performed assuming that the windshield with the water absorption layer on its half of the surface obtained in the above described manner was attached to a minivan in a manner similar to the above actual car running test, and a running test was conducted under the conditions similar to those described above. Specifically, using data of a change in the temperature of the windshield and a change in the temperature and humidity in the car cabin measured in the manner described above, a simulation was performed by the moisture absorption and desorption diffusion simulation calculation model (manufactured by AGC) of the water absorption layer, and the fog occurrence time (ts) was calculated.

The simulation results corresponding to actual measurements in the above four tests are shown in the simulation rows of Table 1. Further, a value “Δ (ts−t)” obtained by subtracting the actual measurement value (t) from the simulation value (ts) is shown together with the fog occurrence time in Table 1.

TABLE 1

| Test Number | | 1st | 2nd | 3rd | 4th |
|---|---|---|---|---|---|
| Untreated Part | Actual measurement | 1′40″ | 2′35″ | 0′55″ | 1′00″ |
| Fog | (t) | | | | |
| Occurrence | Simulation | 1′22″ | 2′54″ | 0′36″ | 0′36″ |
| Time | (ts) | | | | |
| | [symbol] (ts-t) | −18″ | +19″ | −19″ | −24″ |
| Water | Actual Measurement | 4′50″ | 5′15″ | 3′00″ | 3′15″ |
| Absorption | (t) | | | | |
| Layer Fog | Simulation | 4′42″ | 5′44″ | 3′06″ | 2′48″ |
| Occurrence | (ts) | | | | |
| Time | [symbol] (ts-t) | −8″ | +29″ | +6″ | −27″ |

| | | | | |
|---|---|---|---|---|
| DEF Operation Start Time | 5′30″ | 10′30″ | 6′00″ | 5′00″ |

As can be seen from Table 1, it was confirmed that the antifogging performance of the glass plate with the water absorption layer (antifogging glass article) in which the water absorption layer is formed on the glass plate was accurately predicted by a simulation using the moisture absorption and desorption diffusion simulation calculation model.

### EXAMPLES AND COMPARATIVE EXAMPLES

In the following examples and comparative examples, the antifogging performance in an actual vehicle state was predicted and evaluated using the moisture absorption and desorption diffusion simulation calculation model of the water absorption layer verified in the comparison with the results as described above. Regarding the change in the temperature of the windshield and the change in the temperature and humidity inside the car cabin, a profile of the temperature change, humidity change, and windshield temperature change in a typical automobile calculated by thermal simulation software (manufactured by AGC) was used as conditions.

In addition, the environmental conditions for an actual car state in the examples and comparative examples were set corresponding to an actual car in winter and were as follows.

### (Environmental Conditions)

Initial inside car and outside air relative humidity=50%

Initial car inside and outside air temperature=0° C.

Travel speed=40 km/hr

Car cabin volume=3.8 m³

Air conditioning mode=maximum in the foot mode

Fan operation start=3 minutes after driving is started

Dehumidification function=OFF

Outside air introduction rate=22.8 m³/hr (assuming that ventilation of 60 cycles/hr=3.8×60=228 m³/hr is the maximum air flow of air conditioning, and that 10% of air circulation is exchange of air between internal and external air in the internal air circulation mode)

Passenger capacity=4 passengers (in passenger breath, a steam generation rate per person is set to 58 g/hr, which is a typical steam generation rate.)

### (Water Absorption Layer Design)

The water absorption layer was designed based on the water absorption layer produced in the manner described above. As shown in Table 2, 12 types of curable resins constituting the water absorption layer were set so that the moisture diffusion coefficients at 0° C. were equally spaced on the logarithm. In Table 2, a curable resin having a curable resin number of 1 is referred to as a curable resin 1. Other curable resins are also indicated in the same manner as the curable resin 1. The curable resin 5 in Table 2 was a curable resin that constitutes the water absorption layer produced in the manner described above.

The moisture diffusion coefficients D of the curable resins 1 to 4 and the curable resins 6 to 12 were in a range that can be adjusted by appropriately changing the curing conditions for the curable resin 5. The curable resins 1 to 4 can be produced by setting the temperature in the curing conditions for the curable resin 5 to be high and/or by setting a long time in the curing conditions for the curable resin 5. The curable resins 6 to 12 can be produced by setting the temperature in the curing condition for the curable resin 5 to be low and/or setting a short time in the curing conditions for the curable resin 5.

Specifically, the curing conditions for the curable resin 1 having the smallest moisture diffusion coefficient D was that the curing time was 50 minutes in an air circulating oven at a set temperature of 100° C., while the curing conditions for the curable resin 12 having the largest moisture diffusion coefficient D was that the curing time was 20 minutes in an air circulating oven at a set temperature of 100° C.

Moreover, the saturated water absorption amount was calculated for each curable resin, and is also shown in Table 2. The pencil hardness of each curable resin was measured in accordance with JIS K 5600-5-4. The results of measurement of the pencil hardness are also shown in Table 2. The pencil hardness was evaluated after holding an antifogging glass article including a water absorption layer composed of each of the obtained curable resins 1 to 12 for 16 hours or longer in an environment of a temperature of 23±2° C. and a relative humidity of 50±5%.

The film thickness of the water absorption layer can be freely designed to be 100 μm or less in accordance with the setting of the following simulation conditions. The film thickness of the water absorption layer can be adjusted by changing the solvent concentration, viscosity, application method, drying conditions, etc. in the water absorption layer composition when the water absorption layer composed of the curable resin 5 is formed.

The curable resin used in this example is an example of a material that can constitute a water absorption layer, and the present disclosure is not limited to this. Any water absorption material that satisfies the requirements of the saturated water absorption amount and moisture diffusion coefficient D of the water absorption layer according to the present disclosure can be used as a constituent material of the water absorption layer without any particular limitation.

TABLE 2

| | Moisture | Saturated | |
|---|---|---|---|
| | Diffusion | Water | |
| Curable | Coefficient | Absorption | |
| Resin | D | Amount | Pencil |
| Number | [m²/s] | [mg/cm³] | Hardness |
| 1 | 2.19 × 10⁻¹⁴ | 340 | 4H |
| 2 | 4.22 × 10⁻¹⁴ | | |
| 3 | 8.16 × 10⁻¹⁴ | | |
| 4 | 1.57 × 10⁻¹³ | | 3H |
| 5 | 3.04 × 10⁻¹³ | | |
| 6 | 5.87 × 10⁻¹³ | | |
| 7 | 1.13 × 10⁻¹² | | 2H |
| 8 | 2.19 × 10⁻¹² | | |
| 9 | 4.27 × 10⁻¹² | | |
| 10 | 8.16 × 10⁻¹² | | H |
| 11 | 1.57 × 10⁻¹¹ | | F |
| 12 | 3.04 × 10⁻¹¹ | | HB |

### (Simulation Method)

A temperature rise profile obtained from the thermal simulation software starting from 0° C. under the above environmental conditions, and the amount of humidity increase by the passenger breath were the conditions input to the simulation. When a water absorption layer was formed of the above-mentioned 12 kinds of curable resins having the above moisture diffusion coefficients D using the moisture absorption and desorption diffusion simulation calculation model, a required film thickness of each absorption layer was simulated with target predetermined fog occurrence times (5, 10, 15, 20, 25, and 30 minutes).

The obtained calculation results are shown in Table 3 as a list of film thicknesses [μm] for achieving predetermined fog occurrence times at predetermined moisture diffusion coefficients D. In Table 3, the numeral “100” indicates that the target fog occurrence time cannot be achieved even when the thickness of the water absorption layer is increased to 100 [μm]. Further, in each fog occurrence time, “−” is written in a cell where the moisture diffusion coefficient D is smaller than the moisture diffusion coefficient D written as “100”.

TABLE 3

| | | Fog Occurrence Time [min] | | | | | |
|---|---|---|---|---|---|---|---|
| | | 30 | 25 | 20 | 15 | 10 | 5 |
| Moisture | 2.19 × 10⁻¹⁴ | — | — | — | — | — | 100 |
| Diffusion | 4.22 × 10⁻¹⁴ | — | — | — | — | — | 20.5 |
| Coefficient | 8.16 × 10⁻¹⁴ | — | — | — | — | — | 2.9 |
| D[m²/s] | 1.57 × 10⁻¹³ | — | — | — | — | 100 | 2.7 |
| | 3.04 × 10⁻¹³ | — | — | 100 | 100 | 11.8 | 2.7 |
| | 5.87 × 10⁻¹³ | — | 100 | 44.3 | 21.8 | 10.6 | 2.7 |
| | 1.13 × 10⁻¹² | 100 | 42.4 | 30.0 | 19.6 | 10.3 | 2.7 |
| | 2.19 × 10⁻¹² | 48.5 | 38.1 | 28.3 | 18.9 | 10.1 | 2.7 |
| | 4.22 × 10⁻¹² | 46.2 | 36.9 | 27.6 | 18.6 | 10.1 | 2.6 |
| | 8.16 × 10⁻¹² | 45.4 | 36.3 | 27.4 | 18.5 | 10.0 | 2.6 |
| | 1.57 × 10⁻¹¹ | 45.1 | 36.1 | 27.2 | 18.5 | 10.0 | 2.6 |
| | 3.04 × 10⁻¹¹ | 44.9 | 36.0 | 27.2 | 18.4 | 10.0 | 2.6 |

It can be seen from Table 3 that the conditions that allow the fog occurrence time to be 5 minutes or longer were that the moisture diffusion coefficient D was 8.16×10^{31 14} [m²/s] or more and the film thickness was 2.9 [μm] or more for the water absorption layer. When the fog occurrence time can be 5 minutes or longer, it can be said that the antifogging property suitable for actual use, more specifically, one that has an antifogging property level that can ensure that there is an enough time for fog to appear when an automobile starts to travel in an environment with a low outside air temperature can be achieved. When the fog occurrence time can be 5 minutes or longer, the driver can perform an operation for preventing fog on a windshield by looking at the state of fog on a part of the windshield where no water absorption layer is formed. A manual operation to start a defroster and change the air conditioning mode to the outside air introduction mode and the like can be performed safely with a sufficient time.

It can be seen from Table 3 that the conditions that allow the fog occurrence time to be 10 minutes or longer were that the moisture diffusion coefficient D was 3.04×10⁻¹³ [m²/s] or more, and the film thickness was 11.8 [μm] or more for the water absorption layer. When the fog occurrence time can be 10 minutes or longer, the effect of the antifogging property suitable actual use is large. At the time of cold start when the passenger gets in a car, a heater also works, because the water temperature starts to rise to some extent after 10 minutes. Fog does not occur in either of the outside air introduction mode and the inside air circulation auto air-conditioning mode.

It can be seen from Table 3 that the conditions that allow the fog occurrence time to be 15 minutes or longer were that the moisture diffusion coefficient D was 5.87×10⁻¹³ [m²/s] or more, and the film thickness was 21.8 [μm] or more for the water absorption layer. When the fog occurrence time can be 15 minutes or longer, the effect of the antifogging property suitable for actual use is even larger. At the time of cold start when the passenger gets in a car, the water temperature rises considerably after 15 minutes, and the heater works, and thus the effect of the antifogging property is large. The room temperature can be quickly raised without internal air circulation and operating the air conditioner.

From Table 3, it can be seen that the conditions that allow the fog occurrence time to be 20 minutes or longer were that the moisture diffusion coefficient D was 5.87×10⁻¹³ [m²/s] or more and the film thickness was 44.3 [μm] or more for the water absorption layer. Further, when the moisture diffusion coefficient D of the water absorption layer was 1.13×10⁻¹² [m²/s] or more and the film thickness was 30.0 [μm] or more, the fog occurrence time can be 20 minutes or longer.

When the fog occurrence time can be 20 minutes or longer, the effect of the antifogging property suitable for actual use is very large. It is possible to prevent fog to occur without relying on the outside air introduction mode or the dehumidifying auto air conditioner at the time of cold start when the passenger gets in a car. At the time of steady traveling of the car after 20 minutes, the water temperature has risen sufficiently, and the room temperature has also risen, and the combination of the outside air introduction mode and the heater makes it possible to continuously prevent fog to occur, which is a great advantage.

In the same simulation as that described above, when the moisture diffusion coefficient D of the water absorption layer was 3.04×10⁻¹³ [m²/s] and the film thickness of the water absorption layer was 14 [μm], the fog occurrence time was 11 minutes, and thus the effect of the antifogging property suitable for actual use was large.

### Comparative Example

In the same simulation as that described above, the fog occurrence time was less than 5 minutes when the moisture diffusion coefficient D of the water absorption layer was 2.19×10⁻¹⁴ [m²/s] with the film thickness of 100 [μm], when the moisture diffusion coefficient D of the water absorption layer was 3.04×10⁻¹³ [m²/s] with the film thickness of 2.6 [μm], and when the moisture diffusion coefficient D of the water absorption was 3.04×10⁻¹¹ [m²/s] with the film thickness of 2.5 [μm]. Thus, a sufficient effect of the antifogging property suitable for actual use was not achieved.

### Examples A, B, C, Comparative Example D

A water absorption layer composed of curable resins 13 to 16 shown below was formed only on a right half of a main surface on an inner side of a windshield of a minivan, and an actual car running test was performed for evaluation. Examples using the curable resins 13, 15, and 16 were referred to as Examples A, B, and C, respectively. An example using the curable resin 14 is Comparative Example D. Note that the method for measuring a pencil hardness and a glass transition temperature shown below is described above.

### <Formation of Water Absorption Layer>

### (Curable Resin 13, 14)

The curing conditions for the curable resins 13 and 14 were the curing conditions for the curable resin 5 except that the curing time was changed to 15 minutes and 55 minutes in an air circulating oven at a set temperature of 100° C. The water absorption layer composed of the curable resin 13 had a film thickness of 5 μm, a saturated water absorption amount of 340 mg/cm³, a moisture diffusion coefficient D of 5.31×10⁻¹⁰ m2/s, and a pencil hardness of B. The water absorption layer composed of the curable resin 14 had a film thickness of 5 μm, a saturated water absorption amount of 340 mg/cm³, a moisture diffusion coefficient D of 2.20×10⁻¹⁵ m²/s, a pencil hardness of 4H, and a glass transition temperature of 70° C.

### (Curable Resin 15)

A composition obtained by mixing polyisocyanate (N3200 manufactured by Sumitomo Bayer Urethane Co., Ltd.), polyol (Toho Polyol PB-4000 manufactured by Toho Chemical Industry Co., Ltd.) and tetraethoxysilane in such a way that an equivalent ratio of reactive groups of polyisocyanate to hydroxyl groups of polyol becomes 0.7 was applied to a glass substrate, cured, and a curable resin 15 was obtained. The curing conditions for the curable resin 15 were that the curing time was 10 minutes in an oven at a set temperature of 150° C. The water absorption layer composed of the curable resin 15 had a film thickness of 10 μm, a saturated water absorption amount of 280 mg/cm³, a moisture diffusion coefficient D of 8.00×10⁻¹³ m²/s, a pencil hardness of 2H, and a glass transition temperature of 30° C.

### (Curable Resin 16)

A composition containing a curable polyvinyl acetal resin produced by dehydrating and condensing polyvinyl alcohol (Denka Poval B-33 manufactured by Denka Company Ltd.) and acetaldehyde in the presence of hydrochloric acid and tetraethoxysilane was applied to a glass substrate, cured, and then the curable resin 16 was obtained. The water absorption layer composed of the curable resin 16 had a film thickness of 3 μm, a saturated water absorption amount of 400 mg/cm³, a moisture diffusion coefficient D of 1.00×10⁻¹² m²/s, a pencil hardness of 2H, and a glass transition temperature of 20° C. In the above composition, the viscosity of the curable polyvinyl acetal resin was 200 mPa·s, and the degree of acetalization was 50 mol %.

### <Actual Car Running Test>

In the same manner as that described above, a water absorption layer composed of each of the curable resins 13 to 16 was formed only on a right half of a main surface of a windshield on an inner side of a minivan. The actual car running test was conducted four times under the same conditions as those for verifying the moisture absorption and desorption diffusion simulation calculation model. The DEF operation start times for the curable resins 13, 15, and 16 were all between 5 and 20 minutes. However, the DEF operation start times for the curable resin 14 were all less than 5 minutes. The results are shown in Table 4 together with the physical properties of the curable resins 13 to 16.

TABLE 4

| | | | Saturated | | | | |
|---|---|---|---|---|---|---|---|
| | | Moisture | Water | | Glass | | DEF |
| | Curable | Diffusion | Absorption | | Transition | Film | Operation |
| | Resin | Coefficient D | Amount | Pencil | Temperature | Thickness | Start Time |
| | Number | [m²/s] | [mg/cm³] | Hardness | (° C.) | (μm) | (minutes) |
| Example A | 13 | 5.31 × 10⁻¹⁰ | 340 | B | — | 5 | 5 to 20 |
| Example B | 15 | 8.00 × 10⁻¹³ | 280 | 2H | 30 | 10 | 5 to 20 |
| Example C | 16 | 1.00 × 10⁻¹² | 400 | 2H | 20 | 3 | 5 to 20 |
| Comparative | 14 | 2.20 × 10⁻¹⁵ | 340 | 2H | 70 | 5 | Less than 5 |
| Example D | | | | | | | |

From the invention thus described, it will be obvious that the embodiments of the invention may be varied in many ways. Such variations are not to be regarded as a departure from the spirit and scope of the invention, and all such modifications as would be obvious to one skilled in the art are intended for inclusion within the scope of the following claims.

What is claimed is:

1. An antifogging glass article comprising:
a glass plate; and
a water absorption layer on at least a part of a surface of the glass plate, wherein
the water absorption layer includes a saturated water absorption amount of 200 mg/cm³ or more, a thickness of 2 to 50 μm, and a moisture diffusion coefficient of 8×10⁻¹⁴ m²/s or more measured at a temperature of 0° C. by a method defined in JIS K 7209.

2. The antifogging glass article according to claim 1, wherein
the water absorption layer includes a pencil hardness of F to 4H measured at a temperature of 23° C. and a relative humidity of 50% by a method defined in the JIS K 5600.

3. The antifogging glass article according to claim 1, wherein
the water absorption layer includes the thickness of 21 to 50 μm and the moisture diffusion coefficient of 6×10⁻¹³ m²/s or more.

4. The antifogging glass article according to claim 1, wherein
the moisture diffusion coefficient is 1×10⁻¹⁰ m²/s or less.

5. The antifogging glass article according to claim 1, wherein
the water absorption layer includes a water absorption resin, and a glass transition temperature of the water absorption resin is 0 to 110° C.

6. The antifogging glass article according to claim 1, wherein
the water absorption layer includes a curable resin composed of a cured product of a curable component as the water absorption resin, and the curable component has viscosity of 10 to 300 mPa·s at 25° C.

7. The antifogging glass article according to claim 5, wherein
the water absorption resin is a cured product of a curable polyvinyl acetal resin, and a degree of acetalization of the curable polyvinyl acetal resin is 20 to 70 mol %.

8. The antifogging glass article according to claim 5, wherein
the water absorption resin is a cured product of a curable urethane resin including an equivalent ratio of a reactive group of polyisocyanate to a hydroxyl group of polyol of 0.5 to 0.9.

9. The antifogging glass article according to claim 1, wherein
the water absorption layer includes a saturated water absorption amount of 300 to 900 mg/cm³.

10. The antifogging glass article according to claim 1, wherein
the antifogging glass article is used as a window glass for a vehicle.
